(19) United States
(12) Patent Application Publication
(10) Pub. No.: US 2004/0228504 A1
(43) Pub. Date: Nov. 18, 2004

(54) Method and apparatus for processing image

(75) Inventor: Jung-Chou Chang, Hacienda Heights, CA (US)

Correspondence Address: BACON & THOMAS, PLLC, 625 SLATERS LANE, FOURTH FLOOR, ALEXANDRIA, VA, 22314

(73) Assignee: Viswis, Inc., Taipei (TW)

(21) Appl. No.: 10/436,390

(22) Filed: May 13, 2003

(51) Int. Cl. G06K 9/00

(52) U.S. Cl. 382/118

(57) ABSTRACT

The present invention discloses a method and an apparatus for processing images, which is particularly suitable for being used during a brief handshake or encounter. The method of the present invention includes a step of sorting or categorizing captured images according to their features, whereby respective clusters are built. The images in each cluster can be further sorted according to image quality. The results can be output to a display or a database for recognition.

### BACKGROUND OF THE INVENTION

1. Field of the Invention

The present invention relates generally to a method for processing images, and more specifically to a method for processing images in which facial images are captured automatically during an encounter with someone. The present invention also relates to an apparatus employing the above method and optionally further providing function of face recognition.

2. Description of the Related Art

Being able to recognize every faces one has ever met and recall their respective names is very difficult and hence considered a gifted talent. Some successful businessmen are attributed to having such rare ability. We, as a human being, have a psychological need for being recognized, therefore we feel delighted when someone could call our names spontaneously rather than being called by a generic “Sir” or “Madam”.

The brain mechanism for memorizing faces and associating faces to other information, is a prime target of an active interdisciplinary research including neuroscience, psychophysics, and computer science. The general conclusion is that human rely on sophisticated “association” neural network to memorize faces. For example one might memorize someone he/she just met as: “looks just like a former teacher Joe except having no facial hair.” From evolutionary perspective, this is an intuitive and natural way human evolved to do in order to survive. The problem with this innate ability is that too often it makes mistakes for various reasons. For example it tends to be more difficult to recognize faces of different race; difficult to recognize faces having no distinctive features; and without strengthening the “association” by refreshing the memory, the memory simply fades away.

To improve the memory of associating names and their respective faces, we often rely on personal tricks such as exaggerating or caricaturing a face to make the facial image more vivid and hence easier to remember. This type of personal tricks can be taught, but the effectiveness varies. Another way to improve face recall is to utilize an electronic device to synthesize a sketch of a face, along with the person's contact information for later lookup. Many personal digital assistant (PDA) devices sold in the market today already provide this kind of feature. The problem with this type of solution is too cumbersome—it takes substantial amount of time to pick various facial features from an array of preprogrammed features. Even worse, oftentimes the sketch doesn't look natural at all and lack of subtlety, thus render the sketch useless. Therefore, the best way to recall faces is to keep real facial pictures along with contact information. But the problem is, asking a stranger's permission to take his/her picture for face recall purpose is not only socially unacceptable, but also technically unfeasible (e.g. what if both hands are busy.)

In these respects, the present invention substantially departs from the conventional concepts and designs of the prior art, and in so doing provides an apparatus primarily developed for the purpose of capturing facial images automatically during an encounter. The current invention can not only capture facial images for face recall purpose, but also function as a memory aid by recognizing familiar faces during an encounter.

### SUMMARY OF THE INVENTION

The object of the present invention is to provide a method and an apparatus for processing images, which can efficiently process captured images during an encounter with someone.

In order to achieve the above object, the method for processing an image of the present invention primarily includes steps of: a) finding a facial image from a captured image; b) sorting said facial image and storing in a respective cluster according to features thereof; c) sorting facial images stored in said respective cluster according to image quality; and d) outputting data stored in said cluster.

According to the method aforementioned, the apparatus for processing an image of the present invention primarily includes a face detection means, a face sorting means, a quality sorting means, and a memory means. The face detection means is used for detecting a facial image from an image. The face sorting means can sort the facial image according to features thereof. The quality sorting means can sort at least one facial image stored in a correspondent cluster according to image quality. The memory means can store the facial image in clusters.

Technologies applied to the step a) or b) are not restricted, and can be neural networks analysis, principal component analysis (PCA) or eigentemplates analysis. In step c), statistical analysis, histogram analysis or other developed technologies are considered. As for the face detection means, the face sorting means and the quality sorting means can be designed according to the above correspondent technologies.

In general, the step b) or the face sorting means is to sort the facial image according to facial features. Non-facial features such as hairstyle, height, outline, color of clothing, color of hair, etc., also facilitate sorting.

The apparatus of the present invention may further include a termination determine means for determining if entering a power saving mode according to a predetermined signal or condition. Additionally, a communication interface is usually provided for accessing an external database.

Other objects, advantages, and novel features of the invention will become more apparent from the following detailed description and drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 depicts a typical usage situation of an apparatus in accordance with a preferred embodiment of the present invention.

FIG. 2 depicts a pocket-sized face grabber in accordance with the preferred embodiment of the present invention.

FIG. 3 depicts a schematic diagram of circuitry in accordance with the preferred embodiment of the present invention.

FIG. 4 depicts a flow diagram of the process in accordance with the preferred embodiment of the present invention.

### DETAILED DESCRIPTION OF THE PREFERRED EMBODIMENT

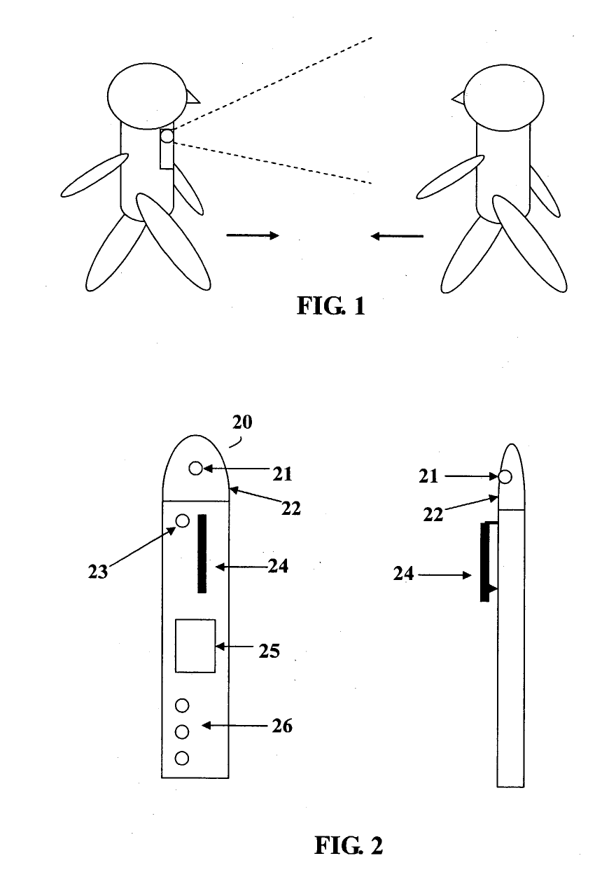

FIG. 1 illustrates a typical usage situation of a preferred embodiment in accordance with the present invention. The apparatus is typically worn in a person's shirt pocket with its lens facing forward. After initiated by various means, the apparatus actively detects and saves valid facial images until it times out after a predetermined period of idling, i.e. not able to find more faces. With a normal lens, as opposed to wide-angle lens or zoom lens, and a popular image resolution of 320 by 240 pixels, the effective distance for capturing valid facial images is somewhere between 50 cm to 3 meters. For different types of applications, the apparatus can be equipped to have an interchangeable lens for different capturing requirements, e.g. a longer or wider effective range. The apparatus can also be made into any shape to accommodate other disguising objects such as hats, neckties, eye glasses, etc. In addition to a portable embodiment, the apparatus can also be embedded in a fixed, i.e. not moving, object or device. For example, an apparatus located at a register counter for automatically detecting customers' faces for security purpose or improved services, i.e. being able to train employees to recognize frequent patrons, or automatically recognize patrons.

FIG. 2 illustrates both the frontal view and side view of a pocket-worn embodiment of the invention, which can be pertinently denominated as “a face grabber” 20. The face grabber 20 is designed to disguise as an oversize pen so that the wearing and operation of the apparatus will be very inconspicuous. By utilizing a so-called pinhole lens, roughly the size of a pin head, it is virtually invisible from even a close distance. The camera lens 21 is mounted on a pivoting camera head 22 so that the apparatus can accommodate people of different heights. A pocket clip 24 helps the apparatus to cling to the shirt pocket or wherever it is suitable for face grabbing operation. The apparatus also has a liquid crystal display (LCD) 25 for browsing facial images and other information, a microphone 23 for recording voice clips, and a few control buttons 26 for controlling the operation of the apparatus.

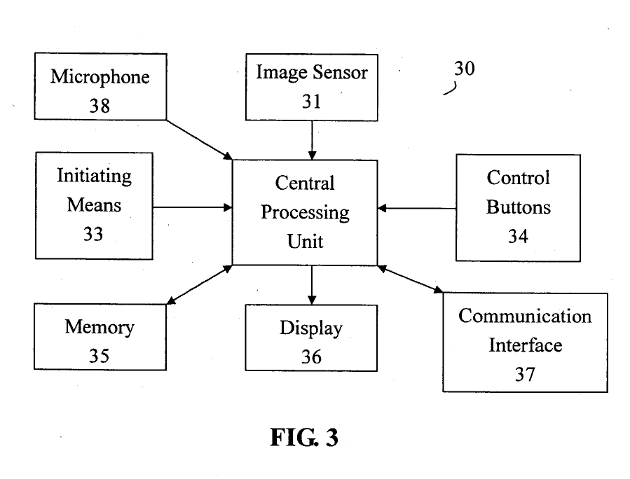

FIG. 3 illustrates a schematic diagram of circuitry 30 of the apparatus 20 (FIG. 2) in accordance with the preferred embodiment of the present invention. The image sensor 31 can be a charge-coupled device (CCD) imager or a complement metal oxide semiconductor (CMOS) imager, for capturing a digital image. For conserving the power, the apparatus 20 is usually in a power saving mode until it is waken up by an initiating means 33. The initiating means 33 may include: a wireless remote control utilizing bluetooth wireless transmission technology, a touch of a button 34, an infrared sensor, a motion sensor, etc. The ultimate goal of the initiating means 33 is to initiate the apparatus 20 in a least conspicuous way. The central process unit (CPU) 32 is to provide computing power for mainly face detection and image compression. Memory 35 is to provide both temporary buffer for computing and permanent storage for saving facial images and other data. A display 36, typically a liquid crystal display (LCD), is mainly for browsing facial images and other data. A communication interface 37 may include a plurality of following: a wireless communication based on bluetooth technology, a universal serial bus (USB) interface, an infrared interface, etc. The communication interface 37 is for transferring data from and to another device, for example, synchronizing facial images and contact information between a computer and the apparatus 20. Control buttons 34 are for many basic operations: setup present date and time, initiating the face grabbing mode, initiating a face recognition mode, initiating a photo taking mode, initiating a voice recording mode using microphone 38, browsing data in various modes, erasing and modifying data in various modes, initiating a communication with another device, etc.

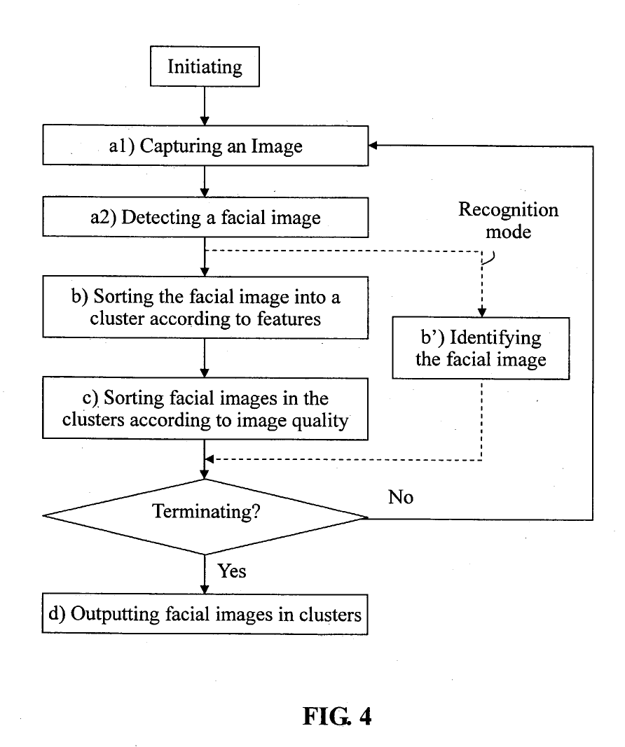

FIG. 4 depicts a flow diagram of the process in accordance with the preferred embodiment of the present invention. An initiating step can be performed by the initiating means 33 in various manner as described in previous paragraph. Once initiated, the process enters a detecting-sorting cycle, from step a1) to step c), until a termination signal is received or a predetermined condition occurs.

For example, a person can initiate the face grabber 20 by touching one of the control buttons 26 just before the person walking toward people. Likely, the person will handshake more than one people in sequence, or back-and-forth. Followed by the initiating step, an image capturing means such as a video camera may be triggered to generate an image in step a1). In the present invention, types of the image data are not restricted to, for example, digital pictures, digital video, analog video, image files, etc. In step a2), the image is processed by a face detection means to detect a facial area. The face detection means can be designed according to an algorithm method such as eigentemplates or neural networks. The algorithms for face detection are readily known in the art.

Step b) utilizes an algorithm method such as principal component analysis (PCA) to sort the detected facial image according to facial features, and then store in a respective cluster in the buffer. The algorithms for clustering faces are readily known in the art. Step b) can further utilize non-facial features (such as color of clothing, color of hair, hair styles, height, outline, etc.) to assist in clustering faces.

Step c) utilizes a statistical method such as histogram analysis around facial features (e.g. eyes, nose, mouth) to sort the facial images in each cluster according to image quality. The technology applied to image quality sorting is also readily known in the art, and very similar to that used for focusing a camera on a target.

In other words, the sorting steps b) and c) solve two problems: 1) avoiding having duplicated facial images, in the situation such as handshaking people back and forth, because the facial images are “presorted by person” in step b); and 2) avoiding having too many or bad facial images, because they are “sorted by image quality” in step c).

The loop can be terminated based upon one or a plurality of following factors: a predetermined period of time, a predetermined period of idling, i.e., not finding any faces, a predetermined number of facial images accumulated in buffer, a motion sensor, a wireless remote control, an infrared sensor, a touch of a button, etc. When a predetermined signal or condition aforementioned is received or occurs, the loop from step a1) to step c) is ended and continue step d). In step d), the facial images with the best quality and related data in buffers are output to a display, an internal or external database or a printing device, etc. Alternatively, the process can automatically terminate and enter power saving mode when the apparatus idles, i.e., not finding any more faces, for more than 30 seconds.

Recording only the facial images and only when the process is initiated, the requirement of storage size can be very small. Even with a moderately equipped low-cost 64-megabytes Flash memory can easily store thousands of facial images, with room to spare for contact information and voice recordings.

Further disclosed, the apparatus of the present invention can have an optional “recognition” mode of operation. The detected facial image is processed by step b′) instead of step b) and c). The step b′) identifies the detected facial image by a principal component analysis (PCA). The result of the identification (e.g. the name associated with the facial image in database) can be sent to a wireless earphone via a communication interface 37. Therefore, the present invention can not only help people to remember faces, but also identify faces automatically in a socially acceptable way.

Although the invention has been described with particular reference to preferred embodiments thereof, variations and modifications of the present invention can be effected within the spirit and scope of the following claims.

What is claimed is:

1. An apparatus for processing an image, comprising:
a face detection means for detecting a facial image from an image;
a face sorting means for sorting said facial image according to features thereof;
a quality sorting means for sorting at least one facial image stored in a correspondent cluster according to image quality; and
a memory means for storing said facial image in clusters.

2. The apparatus of claim 1, wherein said face detection means finds said facial image by neural network analysis.

3. The apparatus of claim 1, wherein said face detection means finds said facial image by principal component analysis (PCA) or eigentemplates.

4. The apparatus of claim 1, wherein said face sorting means sorts said facial image by principal component analysis (PCA).

5. The apparatus of claim 1, wherein said face sorting means sorts said facial image according to facial features.

6. The apparatus of claim 1, wherein said face sorting means sorts said facial image according to non-facial features comprising at least one of hairstyle, height, outline, color of clothing and color of hair.

7. The apparatus of claim 1, wherein said quality sorting means sorts facial images in said clusters by statistical analysis.

8. The apparatus of claim 1, wherein said quality sorting means sorts facial images in said clusters by histogram analysis.

9. The apparatus of claim 1, further comprising a termination determine means for determining if entering a power saving mode according to a predetermined signal or condition.

10. The apparatus of claim 1, further comprising a communication interface for accessing an external database.

11. A method for processing an image, comprising steps of:
a) finding a facial image from a captured image;
b) sorting said facial image and storing in a respective cluster according to features thereof;
c) sorting facial images stored in said respective cluster according to image quality; and
d) outputting data stored in said cluster.

12. The method of claim 11, wherein said step a) is achieved by neural networks analysis.

13. The method of claim 11, wherein said step a) is achieved by principal component analysis (PCA) or eigentemplates analysis.

14. The method of claim 11, wherein said step b) is achieved by principal component analysis (PCA).

15. The method of claim 11, wherein said step b) is to sort said facial image according to facial features.

16. The method of claim 11, wherein said step b) is to sort said facial image according to non-facial features comprising at least one of hairstyle, height, outline, color of clothing and color of hair.

17. The method of claim 11, wherein said step c) is achieved by statistical analysis.

18. The method of claim 11, wherein said step c) is achieved by histogram analysis.

19. The method of claim 11, wherein said step d) is to output said data to a data storage means.
